(19) United States
(12) Patent Application Publication
(10) Pub. No.: US 2025/0176482 A1
(43) Pub. Date: Jun. 5, 2025

(54) COLLABORATIVE CONTROL METHOD FOR PICKING ROBOT BASED ON COLLABORATIVE PICKING AND COLLECTION OF MUSHROOMS

(71) Applicant: AGRICULTURAL INFORMATION INSTITUTE OF CAAS, Beijing (CN)

(72) Inventors: Ning ZHANG, Beijing (CN); Xiujuan CHAI, Beijing (CN); Zhiyu SONG, Beijing (CN); Shuo ZHOU, Beijing (CN); Tan SUN, Beijing (CN)

(21) Appl. No.: 19/051,321

(22) Filed: Feb. 12, 2025

(30) Foreign Application Priority Data
Nov. 14, 2024 (CN) 202411622463.1

(51) Int. Cl. A01G 18/70; B25J 9/00; B25J 9/16; B25J 13/08; B25J 15/06; B25J 19/02; G06V 10/20; G06V 10/82; G06V 20/68

(52) U.S. Cl. CPC A01G 18/70; B25J 9/0093; B25J 9/1664; B25J 9/1669; B25J 9/1697; B25J 13/089; B25J 15/0658; B25J 19/023; G06V 10/20; G06V 10/82; G06V 20/68

(57) ABSTRACT

This application relates to a collaborative control method for a picking robot based on collaborative picking and collection of mushrooms, including the following steps: picking, by a suction cup, the mushrooms, and conveying, by a built-in conveying apparatus, the mushrooms to a discharge port; dynamically adjusting a movement path of the picking robot; synchronously moving a receiving mechanism and the picking robot, and ensuring the receiving mechanism to be aligned to the discharge port; separating, by a separating apparatus, mushrooms that meet a quality standard and unqualified mushrooms, where the mushrooms that meet a quality standard and the unqualified mushrooms respectively enter a first dropping hopper and a second dropping hopper; grading the mushrooms in the first dropping hopper for a second time, classifying the mushrooms based on volumes and diameters of the mushrooms; when any dropping hopper is to be fully loaded, triggering the receiving mechanism to alternately operate.

### CROSS REFERENCE TO RELATED APPLICATION

This patent application claims the benefit and priority of Chinese Patent Application No. 202411622463.1, filed with the China National Intellectual Property Administration on Nov. 14, 2024, the disclosure of which is incorporated by reference herein in its entirety as part of the present application.

### TECHNICAL FIELD

The present disclosure relates to the field of agricultural automation technologies, and in particular, relates to a collaborative control method for a picking robot based on collaborative picking and collection of mushrooms.

### BACKGROUND

With development of automated agriculture and intelligent agriculture, picking of crops such as mushrooms gradually develops to be automated. In a conventional manual picking manner, efficiency is low, a lot of labor is consumed, and mechanical damages to mushrooms are easily caused, affecting product quality and market value. In view of this, picking robots are introduced in the mushroom picking field, achieving preliminary application of automated picking. However, existing picking robots have large deficiency in classification, quality detection, and volume gradation for the mushrooms, and cannot meet requirements for efficient and precise classification and picking in modern agricultural production. Especially, in a mushroom picking process, synchronization and coordination between the receiving mechanism and the picking robot, grading standards of the mushrooms, and intelligent processing in quality detection are still significant challenges faced by the current technology.

In the conventional technology, the maturity, appearances, and volumes of the mushrooms cannot be accurately detected by the picking robot in real time. Consequently, the damage rate in the picking process is high. In addition, in picking operation, there is no comprehensive solution for ensuring the synchronous coordination between the receiving mechanism and the picking robot, and avoiding efficiency decrease caused by load unbalance or interruption in the picking process. In addition, the mushroom grading process largely depending on manual or simple mechanical means is inaccurate without support of a precise algorithm. To resolve the technical problems, it is of important practical significance and necessity to develop a collaborative control method for intelligent mushroom picking, to improve picking efficiency and classifying precision.

### SUMMARY

Based on the objective, the present disclosure provides a collaborative control method for a picking robot based on collaborative picking and collection of mushrooms.

The collaborative control method for a picking robot based on collaborative picking and collection of mushrooms includes the following steps:
S1, moving the picking robot along a cultivation frame, picking, by a suction cup, the mushrooms, and conveying, by a built-in conveying apparatus, the mushrooms to a discharge port;
S2, dynamically adjusting, according to a distribution state and maturity data of the mushrooms, a movement path of the picking robot by using a path planning algorithm, and optimizing a picking path based on a real-time position and a mushroom density;
S3, synchronously moving a receiving mechanism and the picking robot, associating the receiving mechanism with the path planning algorithm, and ensuring the receiving mechanism to be aligned to the discharge port to receive the mushrooms conveyed by the picking robot;
S4, detecting, by an image recognition apparatus mounted on the receiving mechanism, appearances, color, and shapes of the mushrooms based on a preset quality recognition algorithm, and separating, by a separating apparatus, mushrooms that meet a quality standard and unqualified mushrooms, where the mushrooms that meet a quality standard and the unqualified mushrooms respectively enter a first dropping hopper and a second dropping hopper;
S5, grading the mushrooms in the first dropping hopper for a second time, classifying the mushrooms based on volumes and diameters of the mushrooms, and guiding, by the separating apparatus, large mushrooms to a third dropping hopper, and small mushrooms to a fourth dropping hopper; and
S6, when any dropping hopper is to be fully loaded, emitting a full-load signal to trigger the receiving mechanism to alternately operate, and starting a secondary receiving mechanism to ensure that picking and collection operations are continuously performed.

Optionally, the step S1 specifically includes the following steps:
S11, when the picking robot moves along a guide rail of the cultivation frame, controlling, by a drive motor, the picking robot to move back and forth, where the drive motor fits the guide rail on the cultivation frame to implement a stable movement process, and the guide rail is provided with a positioning apparatus to ensure that the pocking robot is capable of being precisely positioned above the mushrooms;
S12, picking, by the picking robot, the mushrooms through the suction cup mounted on a robot arm, where the robot arm vertically stretches according to a preset picking height parameter, and the suction cup is connected to a pneumatic system to separate mature mushrooms from mushroom bodies by using a negative pressure suction principle and stably grab the mature mushrooms; and
S13, conveying, by the picking robot through a built-in conveyor belt, the mature mushrooms grabbed by the suction cup from the suction disc to the discharge port inside the picking robot.

Optionally, the step S2 specifically includes the following steps:
S21, obtaining, by a visual sensor deployed on the picking robot, mushroom distribution and maturity information in a target area, where the sensor is configured to: scan growth positions and volumes of the mushrooms in real time, and generate relevant data;
S22, performing the path planning algorithm based on the obtained mushroom distribution and maturity information, determining an optimal movement path by analyzing a current spatial position of the picking robot, and mushroom information such as the mushroom density, mushroom cap shielding, a mushroom height and mushroom maturity, and selecting a path on which non-destructive picking is capable of being completed within shortest time, to avoid picking in an area with immature mushrooms;
S23, automatically adjusting, by the picking robot, the movement path and a movement speed according to the calculated path, where in the movement process, the real-time position of the picking robot is continuously obtained, and the movement path is dynamically adjusted according to mushroom information in a to-be-picked area and newly collected data, to optimize the picking path and avoid repeated picking and missed picking; and
S24, when the picking robot approaches the target area, fine-tuning a movement position of the picking robot by using real-time feedback information to ensure that the picking robot reaches an optimal picking distance when approaching a target mushroom, to achieve a precise picking operation.

Optionally, the step S22 specifically includes the following steps:
S221, obtaining space distribution information of the mushrooms, and recording a current position of the picking robot to know positions of the mushrooms and a relative position of the picking robot, where the space distribution information includes a three-dimensional coordinate position and maturity of each mushroom;
S222, calculating a movement distance from the picking robot to each mushroom based on a relative distance from the current position of the picking robot to each mushroom, and sorting the mushrooms according to the movement distances to give priority to a mushroom with a shorter movement distance;
S223, considering the maturity of the mushroom, and distributing a weight value to each mushroom by combining the maturity with the movement distance, and giving a higher priority μ₁ to a mushroom with higher maturity and a shorter movement distance;
S224, considering the mushroom cap shielding and the mushroom height, and giving a higher priority μ₂ to a mushroom with higher maturity, a shorter movement distance, a larger height and no shielding by combining the mushroom cap shielding, the mushroom height, and the weight μ₁ distributed in consideration of the maturity and the movement distance;
S225, selecting a mushroom with a greatest weight value μ₂ as a picking target by using a greedy algorithm, updating a position of the mushroom and the relative position of the picking robot and continuously selecting a next mushroom with a higher priority after the picking robot moves to the position of the mushroom with the greatest weight value μ₂, and repeating the process until all mushrooms that meet a maturity requirement are picked; and
S226, planning the entire picking path according to a principle of minimizing a total movement distance, to ensure that the picking robot is capable of picking all target mushrooms in a shortest path in sequence.

Optionally, the step S24 specifically includes the following steps:
S241, when the picking robot approaches a target mushroom area, obtaining, by a real-time position sensor, a relative distance from the picking robot to the target mushroom, and recording transverse and longitudinal position deviations between the current position of the picking robot and the target mushroom;
S242, performing position fine-tuning based on obtained position deviation information by using a proportional-integral-derivative control algorithm, and dynamically adjusting the movement speed and a movement direction of the picking robot according to a distance error, to ensure that the picking robot gradually approaches the target mushroom; and
S243, when the distance error between the picking robot and the target mushroom is reduced to be within a preset range, that is, when an optimal picking distance is reached, reducing, by a proportion integration differentiation (PID) controller, the movement speed to keep stable position precision and ensure that the suction cup is aligned to the target mushroom for picking.

Optionally, the step S3 specifically includes the following steps:
S31, when the picking robot is started, firstly obtaining real-time position information of the picking robot, and transmitting the real-time position information to the receiving mechanism, where the real-time position information includes current coordinates and a movement speed of the picking robot on the cultivation frame;
S32, adjusting, by the receiving mechanism, a movement path of the receiving mechanism based on the real-time position information provided by the picking robot by using a synchronous tracking algorithm, to ensure that the receiving mechanism and the picking robot are kept at a consistent speed and in a consistent movement direction; and
S33, continuously monitoring relative positions between the receiving mechanism and the discharge port of the picking robot, and when a deviation is detected, automatically adjusting the movement speed and the movement direction of the receiving mechanism until the deviation between the receiving mechanism and the discharge port is reduced to be within a preset range, to ensure that the discharge port is exactly aligned to a receiving area.

Optionally, the step S4 specifically includes the following steps:
S41, collecting, by the image recognition apparatus, an appearance image of each collected mushroom, where the image recognition apparatus includes a high-definition camera and a light source system, the high-definition camera is configured to: shoot an appearance, color and a shape feature of the mushroom, and generate corresponding digital image data, and the light source system is configured to ensure that image quality is stable;
S42, inputting the collected mushroom image data into a preset quality recognition algorithm, and comparing the collected mushroom image data with a qualified mushroom template in a quality standard library to determine whether the mushroom meets a preset standard;
S43, classifying the mushrooms into qualified mushrooms and unqualified mushrooms according to a detection result in S42, where the qualified mushroom has an appearance, color, and a shape feature that meet a set standard, and the unqualified mushroom has an obvious difference and defect from the qualified mushroom template; and
S44, after the detection result is transmitted to a central control system, starting the separating apparatus according to a determining result, where the separating apparatus is configured to: control runners in two different directions through an executor, guide the qualified mushrooms to the first dropping hopper through one hopper, and guide the unqualified mushrooms to the second dropping hopper through the other runner.

Optionally, the step S42 specifically includes the following steps:
S421, preprocessing, by the image recognition apparatus, the collected mushroom image, where the preprocessing includes noise removal, color balance adjustment, and edge detail enhancement; and after image processing, extracting color information and brightness information of each pixel, where the color information includes red color, green color, and blue color;
S422, extracting feature information of the mushroom from the preprocessed image by using a convolutional neural network, where the feature information includes color information and shape parameters of the mushrooms, the color information is obtained by analyzing a color histogram, and specifically includes color distribution of red, green, and blue channels; and the shape parameter is extracted through edge detection and outline analysis, and is used to reflect symmetry, a shape, and a surface feature of the mushroom;
S423, comparing the extracted mushroom feature information with the preset qualified mushroom template in the quality standard library, where the template includes color and a shape feature of a standard mushroom; and estimating a matching degree between the appearance, color, and shape of the mushroom with those in an eligibility standard by calculating a difference value between the mushroom and the qualified mushroom template; and
S424, according to a comparison result, determining whether the mushroom meets a preset quality standard based on the difference value between the mushroom and the qualified template; and determining that the mushroom is a qualified mushroom if a feature difference of the mushroom is within a preset tolerance range; or determining that the mushroom is an unqualified mushroom if the feature difference of the mushroom exceeds a preset tolerance range.

Optionally, the step S5 specifically includes the following steps:
S51, in the first dropping hopper, measuring, by the image recognition apparatus, a volume and a diameter of each mushroom;
S52, separately comparing the volume and the diameter with a preset volume grading standard, and setting different volume thresholds and diameter thresholds based on types and specifications of the mushrooms according to the volume grading standard; and if both a volume and a diameter of the mushroom exceed the preset thresholds, determining that the mushroom is a large mushroom; or if both a volume and a diameter of the mushroom are lower than the preset thresholds, determining that the mushroom is a small mushroom; and
S53, guiding the large mushroom to the third dropping hopper according to a grading result, and guiding the small mushroom to the fourth dropping hopper according to a determining result, to avoid that mushrooms of different volumes are mixed.

Optionally, the step S6 specifically includes the following steps:
S61, mounting a load sensor in each dropping hopper, where the load sensor is configured to: monitor a current load of the dropping hopper in real time, and transmit current weight data W that is measured by the load sensor to the central control system, where W is an actual weight of mushrooms in the dropping hopper;
S62: continuously monitoring, by the central control system, the current weight W according to a preset full-load threshold Wₘₐₓ; and when the current weight W measured by the load sensor is close to or equal to the full-load threshold Wₘₐₓ, that is, when W≥Wₘₐₓ is met, automatically emitting, by the central control system, a full-load signal; and
S63, after the full-load signal is transmitted to the central control system, triggering the secondary receiving mechanism to start; after the secondary receiving mechanism is in a standby state in advance and the full-load signal is emitted, sending, by the central control system, an instruction to an executor, and switching a receiving path by the executor, to ensure that the secondary receiving hopper takes over an existing receiving hopper, to continuously perform a receiving operation.

The present disclosure has following beneficial effects:

According to the present disclosure, the path planning algorithm, real-time feedback control, and an intelligent grading system are introduced to resolve the problem that there is no precise detection and synchronization control in a process of picking the mushrooms by the picking robot in the prior art. The maturity, volumes, and quality of the mushrooms can be precisely determined by monitoring growth states, volume parameters, and diameter parameters of the mushrooms in real time and combining with an intelligent grading algorithm, such that automatic sorting and processing for mushrooms of different types are achieved. In a system, through a synchronous operation between the receiving mechanism and the picking robot, a receiving process and a picking process are joined seamlessly, such that interruption is avoided, and picking efficiency is greatly improved.

According to the present disclosure, a signal is emitted when the dropping hopper is to be fully loaded, to automatically switch to the secondary receiving mechanism, such that the picking operation is continuously performed. Compared with a conventional manual picking manner or simple mechanical sorting manner, the picking manner in the present disclosure remarkably reduces a damage rate of the mushrooms, improves sorting precision, and improves intelligent level of the entire picking process.

### BRIEF DESCRIPTION OF THE DRAWINGS

In order to describe the technical solutions in the present disclosure or in the prior art more clearly, the accompanying drawings required for describing embodiments or the prior art are briefly described below. Apparently, the accompanying drawings in the following description show merely the present disclosure. Those of ordinary skill in the art can still derive other accompanying drawings from these accompanying drawings without creative efforts.

FIG. 1 is a schematic flow chart of a method for cooperative control of a picking robot based on collaborative picking and collection of mushrooms according to an embodiment of the present disclosure; and

FIG. 2 is a schematic flow chart of a path planning algorithm according to an embodiment of the present disclosure.

### DETAILED DESCRIPTION OF THE EMBODIMENTS

The present disclosure is described below in detail by using specific embodiments with reference to the accompanying drawings. Meanwhile, it needs to be explained here that in order to make the embodiments more detailed, the following embodiments are the best and preferred embodiments. For some well-known technologies, those skilled in the art can also implement them in other alternative ways. The drawings are only intended to describe the embodiments more specifically, rather than to define the present disclosure specifically.

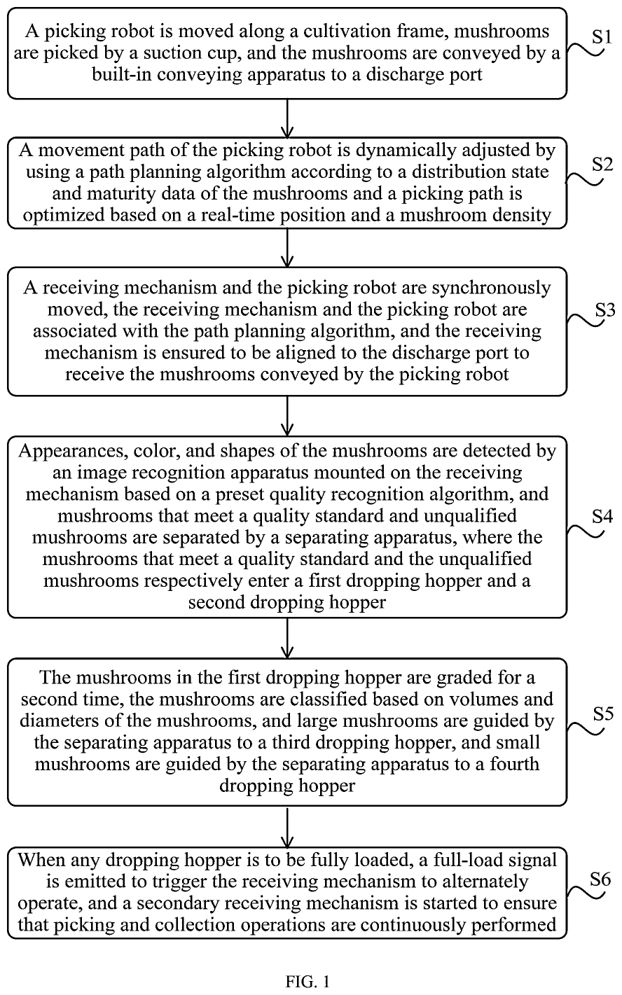

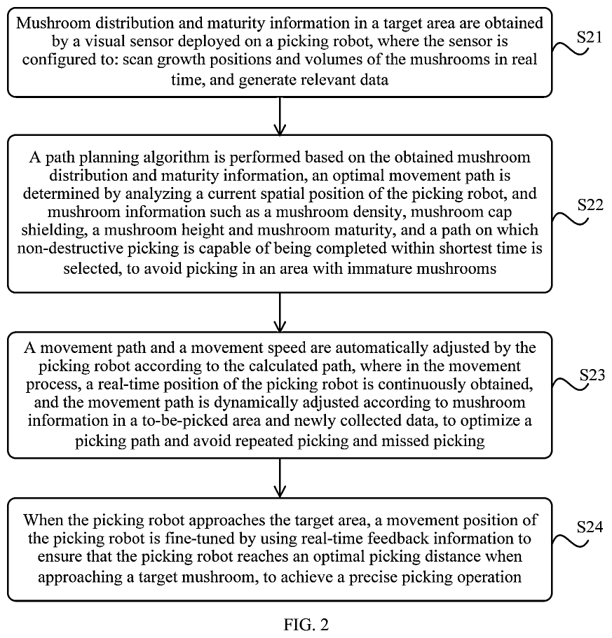

As shown FIG. 1 and FIG. 2, a collaborative control method for a picking robot based on collaborative picking and collection of mushrooms includes the following steps.

In step S1, the picking robot is moved along a cultivation frame, the mushrooms are picked by a suction cup, and the mushrooms are conveyed by a built-in conveying apparatus to a discharge port.

In step S2, a movement path of the picking robot is dynamically adjusted by using a path planning algorithm according to a distribution state and maturity data of the mushrooms and a picking path is optimized based on a real-time position and a mushroom density.

In step S3, a receiving mechanism and the picking robot are synchronously moved, the receiving mechanism and the picking robot are associated with the path planning algorithm, and the receiving mechanism is ensured to be aligned to the discharge port to receive the mushrooms conveyed by the picking robot.

In step S4, appearances, color, and shapes of the mushrooms are detected by an image recognition apparatus mounted on the receiving mechanism based on a preset quality recognition algorithm, and mushrooms that meet a quality standard and unqualified mushrooms are separated by a separating apparatus, where the mushrooms that meet a quality standard and the unqualified mushrooms respectively enter a first dropping hopper and a second dropping hopper.

In step S5, the mushrooms in the first dropping hopper are graded for a second time, the mushrooms are classified based on volumes and diameters of the mushrooms, and large mushrooms are guided by the separating apparatus to a third dropping hopper, and small mushrooms are guided by the separating apparatus to a fourth dropping hopper.

In step S6, when any dropping hopper is to be fully loaded, a full-load signal is emitted to trigger the receiving mechanism to alternately operate, and a secondary receiving mechanism is started to ensure that picking and collection operations are continuously performed.

The step S1 specifically includes the following steps.

In step S11, when the picking robot moves along a guide rail of the cultivation frame, the picking robot is controlled by a drive motor to move back and forth, where the drive motor fits the guide rail on the cultivation frame to implement a stable movement process, and the guide rail is provided with a positioning apparatus to ensure that the pocking robot is capable of being precisely positioned above the mushrooms.

In step S12, the mushrooms are picked by the picking robot through the suction cup mounted on a robot arm, where the robot arm vertically stretches according to a preset picking height parameter, and the suction cup is connected to a pneumatic system to separate mature mushrooms from mushroom bodies by using a negative pressure suction principle and stably grab the mature mushrooms.

In step S13, the mature mushrooms grabbed by the suction cup are conveyed by the picking robot through a built-in conveyor belt from the suction disc to the discharge port inside the picking robot, where the conveyor belt is provided with a speed-adjustable control apparatus to ensure that the mushrooms are prevented from being damaged in a transmission process, and a tail end of the conveyor belt is in seamless joint to the discharge port to smoothly output the mushrooms; and through specific movement control in the foregoing steps, picking using the suction cup, and collaborative work of the conveying apparatus, the picking robot can be precisely positioned, and the mushrooms are effectively picked and safety conveyed, such that the mushrooms are efficiently picked with a low damage rate, and picking efficiency and quality is improved.

The step S2 specifically includes the following steps.

In step S21, mushroom distribution and maturity information in a target area are obtained by a visual sensor deployed on the picking robot, where the sensor is configured to: scan growth positions and volumes of the mushrooms in real time, and generate relevant data.

In step S22, the path planning algorithm is performed based on the obtained mushroom distribution and maturity information, an optimal movement path is determined by analyzing a current spatial position of the picking robot, and mushroom information such as the mushroom density, mushroom cap shielding, a mushroom height and mushroom maturity, and a path on which non-destructive picking is capable of being completed within shortest time is selected, to avoid picking in an area with immature mushrooms.

In step S23, the movement path and a movement speed are automatically adjusted by the picking robot according to the calculated path, where in the movement process, the real-time position of the picking robot is continuously obtained, and the movement path is dynamically adjusted according to mushroom information in a to-be-picked area and newly collected data, to optimize the picking path and avoid repeated picking and missed picking.

In step S24, when the picking robot approaches the target area, a movement position of the picking robot is fine-tuned by using real-time feedback information to ensure that the picking robot reaches an optimal picking distance when approaching a target mushroom, to achieve a precise picking operation, where in the foregoing steps, the mushroom distribution and the maturity data are obtained in real time, and the path planning algorithm is dynamically adjusted, thereby achieving efficient picking path planning for the picking robot in different picking areas, improving picking efficiency and precision, avoiding repeated picking and missed picking, and improving overall operation efficiency.

The step S22 specifically includes the following steps.

In step S221, space distribution information of the mushrooms is obtained, and a position of the mushroom and a relative position of the picking robot is recorded to know positions of the mushrooms and a relative position of the picking robot, where the space distribution information includes a three-dimensional coordinate position and maturity of each mushroom; and the data is used to construct a model of a picking area to make the positions of the mushrooms and the relative position of the picking robot clear.

In step S222, a movement distance from the picking robot to each mushroom is calculated based on a relative distance from the current position of the picking robot to each mushroom, and the mushrooms are sorted according to the movement distances to give priority to a mushroom with a shorter movement distance.

In step S223, the maturity of the mushrooms is considered, a weight value is distributed to each mushroom by combining the maturity with the movement distance, and a higher priority μ₁ is distributed to a mushroom with higher maturity and a shorter movement distance.

In step S224, the mushroom cap shielding and the mushroom height are considered, and a higher priority μ₂ is given to a mushroom with higher maturity, a shorter movement distance, a larger height and no shielding by combining the mushroom cap shielding, the mushroom height, and the weight μ₁ distributed in consideration of the maturity and the movement distance.

In step S225, a mushroom with a greatest weight value μ₂ is selected as a picking target by using a greedy algorithm, a position of the mushroom and a relative position of the picking robot are updated and a next mushroom with a higher priority is continuously selected after the picking robot moves to the position of the mushroom with the greatest weight value μ₂, and the process is repeated until all mushrooms that meet a maturity requirement are picked.

In step S226, the entire picking path is planned according to a principle of minimizing a total movement distance, to ensure that the picking robot is capable of picking all target mushrooms in a shortest distance in sequence.

Calculation steps for specifically implementing the path planning algorithm are as follows.

First, space distribution information of all mushrooms in the target area is obtained, and a three-dimensional coordinate position (xᵢ, yᵢ, zᵢ) of each mushroom is collected, where (xᵢ, yᵢ, zᵢ) are horizontal coordinates of a mushroom i, yᵢ is a coordinate of the mushroom i in a longitudinal direction, zᵢ is a coordinate of the mushroom i in a depth direction, and maturity Mᵢ of each mushroom is recorded, where Mᵢ represents a maturity level of the mushroom i; and coordinates of the current position of the picking robot are set as (xᵣ, yᵣ, zᵣ), where xᵣ, yᵣ, and zᵣ are respectively coordinates of the picking robot in transverse, longitudinal, and depth directions.

Then, an Euclidean distance dᵢ between the current position of the picking robot and the target mushroom i is calculated through the path planning algorithm, and a calculation formula is as follows: dᵢ=\sqrt{(xᵢ−xᵣ)²+(yᵢ−yᵣ)²+(zᵢ−zᵣ)²}, where dᵢ is a distance between the mushroom i and the current position of the picking robot, (xᵢ, yᵢ, zᵢ) are coordinates of the mushroom i, (xᵣ, yᵣ, zᵣ) are coordinates of the picking robot, and the distance dᵢ is used to determine a relative distance from the mushroom to the picking robot.

Then, a weight value Wᵢ is distributed to each mushroom in combination with the maturity Mᵢ and the distance dᵢ of the mushroom, and a calculation formula is as follows:

$${W}_{i} = \frac{{M}_{i}}{{d}_{i}} ,$$

where Wᵢ represents the weight value of the mushroom, Mᵢ is the maturity of the mushroom i, dᵢ is a distance between the mushroom i and the picking robot, the weight value is used for comprehensively measuring the maturity and picking cost (namely, the distance) of the mushroom, and a larger weight value indicates a higher priority of picking the mushroom.

Finally, a mushroom with a largest weight value Wᵢ is iteratively selected as a next picking target by using the greedy algorithm, and the current position of the picking robot is updated as new coordinates (xᵣ′, yᵣ′, zᵣ′), where xᵣ′, yᵣ′, and zᵣ′ are updated coordinates of the picking robot; and an Euclidean distance between the picking robot and a remaining mushroom is recalculated based on a new position of the picking robot, and iterative selection is continuously performed until all mushrooms with maturity meeting the standard are picked.

A total path length is L, and a calculation formula is as follows:

L=Σᵢ₌₁ⁿ\sqrt{(xᵢ−xᵣ)²+(yᵢ−yᵣ)²+(zᵢ−zᵣ)²}, where L represents a total movement distance of the picking robot, L is a total number of mushrooms in the target area, xᵢ and yᵢ are coordinates of the mushroom xᵢ, xᵣ and yᵣ are coordinates of the current position of the picking robot; the path planning algorithm is to minimize the length of total path, to ensure that all mushrooms that meet a quality standard are picked by the picking robot within shortest time; and in the foregoing steps, Euclidean distance calculation, weight distribution, and the greedy algorithm are combined to precisely optimize the picking path, such that not only picking can be preferably planned according to the maturity of the mushroom and the distance, but also consumed time for movement can be reduced through a shortest path algorithm. Therefore, picking efficiency is remarkably improved.

The S24 specifically includes the following steps.

In step S241, when the picking robot approaches a target mushroom area, a relative distance from the picking robot to the target mushroom is obtained by a real-time position sensor, and transverse and longitudinal position deviations between the current position of the picking robot and the target mushroom are recorded and respectively represented as Δx=xᵢ−xᵣ, Δy=yᵢ−yᵣ, and Δz=zᵢ−zᵣ, where xᵢ, yᵢ, and zᵢ are coordinates of the mushroom, and xᵣ, yᵣ, and zᵣ are current three-dimensional coordinate positions of the picking robot.

In step S242, position fine-tuning is performed based on obtained position deviation information by using a proportional-integral-derivative (PID) control algorithm, where the PID algorithm is used to adjust movement of the picking robot according to the following formula:

$${P}_{output} = {K}_{p} \cdot Δ d + {K}_{i} \cdot \int Δ ddt + {K}_{d} \cdot \frac{d ( Δ d )}{dt} ,$$

where Δd is a distance error between the current position of the picking robot and the target mushroom, Kₚ is a proportional coefficient, Kᵢ is an integral coefficient, and K_{d} is a differential coefficient; the movement speed and a movement direction of the picking robot are dynamically controlled by a PID controller according to the distance error, to ensure that the picking robot gradually approaches the target mushroom.

In step S243, when the distance error between the picking robot and the target mushroom is reduced to be within a preset range, that is, when an optimal picking distance is reached, the movement speed is further reduced by the PID controller to keep stable position precision and ensure that the suction cup is aligned to the target mushroom for picking. In the foregoing steps, when the picking robot approaches the target mushroom, precise position adjustment can be achieved through the PID control algorithm and real-time position information feedback, to ensure that the picking robot reaches the optimal picking distance. In this process, the movement speed and the movement direction are automatically adjusted, such that positioning precision is improved, and accuracy and stability of the picking operation are ensured.

The step S3 specifically includes the following steps.

In step S31, when the picking robot is started, real-time position information of the picking robot is firstly obtained, and the real-time position information is transmitted to the receiving mechanism, where the real-time position information includes current coordinates and a movement speed of the picking robot on the cultivation frame.

In step S32, a movement path of the receiving mechanism is adjusted based on the real-time position information provided by the picking robot by using a synchronous tracking algorithm, to ensure that the receiving mechanism and the picking robot are kept at a consistent speed and in a consistent movement direction, where the synchronous tracking algorithm is used to calculate the relative distance between the picking robot and the receiving mechanism according to the following calculation formula:

ΔD=\sqrt{(xᵣ−xₛ)²+(yᵣ−yₛ)²+(zᵣ−zₛ)²}, where (xᵣ, yᵣ, zᵣ) is the position of the picking robot, (xₛ, yₛ, zₛ) is the position of the receiving mechanism, and ΔD is used to determine a space bias between the receiving mechanism and the picking robot.

In step S33, relative positions between the receiving mechanism and the discharge port of the picking robot are continuously monitored by the system through position feedback control, to ensure that the receiving mechanism is precisely aligned to the discharge port of the picking robot; and when a deviation is detected, the movement speed and the movement direction of the receiving mechanism are automatically adjusted until the deviation between the receiving mechanism and the discharge port is reduced to be within a preset range, to ensure that the discharge port is exactly aligned to a receiving area. In the foregoing steps, through the synchronous tracking algorithm and the position feedback control technology, the receiving mechanism and the picking robot can be ensured to be in precise synchronous movement, to ensure that the receiving mechanism is accurately aligned to the discharge port. In this process, the position and the speed of the receiving mechanism are dynamically adjusted through real-time data feedback, thereby ensuring receiving efficiency and accuracy in the mushroom picking process, and reducing errors and loss.

The step S4 specifically includes the following steps.

In step S41, an appearance image of each collected mushroom is collected by the image recognition apparatus, where the image recognition apparatus includes a high-definition camera and a light source system, the high-definition camera is configured to: shoot an appearance, color and a shape feature of the mushroom, and generate corresponding digital image data, and the light source system is configured to ensure that image quality is stable.

In step S42, the collected mushroom image data is input into a preset quality recognition algorithm, and the collected mushroom image data is compared with a qualified mushroom template in a quality standard library to determine whether the mushroom meets a preset standard, where parameters in the algorithm include indexes such as color saturation, surface smoothness, and symmetry of a mushroom shape.

In step S43, the mushrooms are classified into qualified mushrooms and unqualified mushrooms according to a detection result in S42, where the qualified mushroom has an appearance, color, and a shape feature that meet a set standard, and the unqualified mushroom has an obvious difference and defect from the qualified mushroom template.

In step S44, after the detection result is transmitted to the central control system, the separating apparatus is started according to a determining result, where the separating apparatus is configured to: control runners in two different directions through an executor, guide the qualified mushrooms to the first dropping hopper through one hopper, and guide the unqualified mushrooms to the second dropping hopper through the other runner. In the separation process, each type of mushrooms are ensured to separately enter a specified dropping hopper through an electrically-controlled mechanical separating plate; in the foregoing steps, through the quality recognition algorithm of a deep learning model, the appearance, color, and shape feature of the mushroom can be efficiently and precisely detected, and qualified and unqualified mushrooms are separated in real time; and the electrically-controlled separating apparatus is combined to ensure automation and high precision of the mushroom separation process, reduce manual intervention and a determining error, and improve sorting efficiency and accuracy.

The step S42 specifically includes the following steps.

In step S421, the collected mushroom image is preprocessed by the image recognition apparatus to ensure definition and accuracy of the image, where the preprocessing includes noise removal, color balance adjustment, and edge detail enhancement; and after image processing, color information and brightness information of each pixel are extracted, where the color information includes red color, green color, and blue color.

In step S422, feature information of the mushroom is extracted from the preprocessed image by using a convolutional neural network, where the feature information includes color information and shape parameters of the mushrooms, the color information is obtained by analyzing a color histogram, and specifically includes color distribution of red, green, and blue channels; and the shape parameter is extracted through edge detection and outline analysis, and is used to reflect symmetry, a shape, and a surface feature of the mushroom.

In step S423, the extracted mushroom feature information is compared with the preset qualified mushroom template in the quality standard library, where the template includes color and a shape feature of a standard mushroom; and a matching degree between the appearance, color, and shape of the mushroom with those in an eligibility standard is estimated by calculating a difference value between the mushroom and the qualified mushroom template.

In step S424, according to a comparison result, it is determined whether the mushroom meets a preset quality standard based on the difference value between the mushroom and the qualified template; and it is determined that the mushroom is a qualified mushroom if a feature difference of the mushroom is within a preset tolerance range; or it is determined that the mushroom is an unqualified mushroom if the feature difference of the mushroom exceeds a preset tolerance range.

Specific calculation steps of the step S42 are as follows:

First, the mushroom image data obtained through the image recognition apparatus is preprocessed, and the image is converted into a two-dimensional pixel matrix after being preprocessed, where each pixel point includes color and brightness information, and separation and analysis are performed according to values of R (red), G (green), and B (blue) channels.

Then, a feature of the processed image is extracted, and the appearance, color, and shape feature of the mushroom are extracted by using the convolutional neural network; and a feature vector is set as Fᵢ that represents a feature of the mushroom i, where the feature includes a color value Cᵢ and a shape parameter Sᵢ. In this case, Fᵢ=(Cᵢ, Sᵢ), the color value Cᵢ is obtained through color histogram analysis, and includes strength distribution of red, green, and blue channels; and the shape parameter Sᵢ indicates symmetry and a shape of the mushroom that are extracted through the edge detection and outline analysis.

Then, the extracted feature vector Fᵢ is compared with a qualified mushroom template Tⱼ in the quality standard library, where Tⱼ represents an j^{th} qualified mushroom template in the quality standard library; the template Tⱼ also includes a color and shape feature vector Tⱼ=(Cᵢ, Sᵢ); during comparison, a difference between the feature of the mushroom i and the qualified template j is calculated according to the Euclidean distance formula: dᵢⱼ=\sqrt{Σₖ₌₁ⁿ^{₁}(F_{i,k}−T_{j,k})²}, where dᵢⱼ represents an Euclidean distance between the mushroom i and the template j, F_{i,k} and T_{j,k} are respectively kth feature components of the mushroom i and the template j, and n₁ represents a total number of dimensions for comparing mushroom features, namely, a number of features included in the feature vector.

In step S424, it is determined whether the mushroom meets the quality standard according to a value of the Euclidean distance dᵢⱼ; if the Euclidean distance between the mushroom and the template is less than a preset threshold ϵ, namely, dᵢⱼ<ϵ, it is determined that the mushroom is a qualified mushroom; otherwise, it is determined that the mushroom is an unqualified mushroom; the threshold ϵ is preset in the quality standard library, and is adjusted according to different types and specifications of the mushrooms. In the foregoing steps, image feature extraction is performed by using the convolutional neural network, and the difference between the mushroom and the qualified template is calculated in combination with the Euclidean distance, such that the appearance, color, and shape of the mushroom can be precisely compared and determined. Through the algorithm, qualified and unqualified mushrooms can be effectively distinguished, thereby ensuring high precision of the recognition process, and improving efficiency and accuracy of automatic grading.

The step S5 specifically includes the following steps.

In step S51, in the first dropping hopper, a volume and a diameter of each mushroom are measured by the image recognition apparatus, where the image recognition apparatus includes a three-dimensional scanning system and an image processing software, the three-dimensional scanning system is configured to: generate a three-dimensional model of the mushroom, and calculate a volume of the mushroom according to the model; and the image processing software is configured to determine a maximum diameter of the mushroom through an image edge detection technology.

In step S52, the volume and the diameter are compared with a preset volume grading standard, and different volume thresholds and diameter thresholds are set based on types and specifications of the mushrooms according to the volume grading standard; and if both a volume and a diameter of the mushroom exceed the preset thresholds, it is determined that the mushroom is a large mushroom; or if both a volume and a diameter of the mushroom are lower than the preset thresholds, it is determined that the mushroom is a small mushroom.

In step S53, the large mushroom is guided to the third dropping hopper according to a grading result, and the small mushroom is guided to the fourth dropping hopper according to a determining result, to avoid that mushrooms of different volumes are mixed. The volume and the diameter of the mushroom are precisely measured through the image recognition apparatus, and the mushrooms are automatically sorted according to the grading standard, thereby ensuring that the large and small mushrooms can be precisely separated, effectively improving sorting efficiency, and reducing a mushroom mixing risk.

The S6 specifically includes the following steps.

In step S61, a load sensor is mounted in each dropping hopper, where the load sensor is configured to: monitor a current load of the dropping hopper in real time, and transmit current weight data W that is measured by the load sensor to the central control system, where W is an actual weight of mushrooms in the dropping hopper.

In step S62, the current weight W is continuously monitored by the central control system according to a preset full-load threshold Wₘₐₓ (the threshold is set according to a maximum capacity of the dropping hopper); and when the current weight W measured by the load sensor is close to or equal to the full-load threshold Wₘₐₓ, that is, when W≥Wₘₐₓ is met, a full-load signal is automatically emitted by the central control system.

In step S63, after the full-load signal is transmitted to the central control system, the secondary receiving mechanism is triggered to start; after the secondary receiving mechanism is in a standby state in advance and the full-load signal is emitted, an instruction is sent by the central control system to the executor, and a receiving path is switched by the executor, to ensure that the secondary receiving hopper takes over an existing receiving hopper, to continuously perform a receiving operation. The dropping hopper that is originally fully-loaded is recorded as being in a full-load state, and is isolated from the current operation, such that a worker is instructed to clear and replace the fully-loaded dropping hopper. In this case, the receiving mechanism is configured to take over all receiving tasks, ensuring that the entire picking operation is seamlessly and continuously performed.

The present disclosure covers any substitution, modification, equivalent method and solution made within the spirit and scope of the present disclosure. For a better understanding of the present disclosure, the specific details of the following preferred embodiments of the present disclosure are explained hereinafter in detail, while the present disclosure can also be fully understood by those skilled in the art without the description of these details. In addition, in order to avoid unnecessary confusion of the essence of the present disclosure, well-known methods, processes, flowcharts, elements, and circuits are not described in detail.

The foregoing description is only preferred implementation of the present disclosure. It should be noted that a person of ordinary skill in the art can also make several improvements and modifications without departing from the principle of the present disclosure. These improvements and modifications should also be deemed as falling within the protection scope of the present disclosure.

What is claimed is:

1. A collaborative control method for a picking robot based on collaborative picking and collection of mushrooms, comprising the following steps:
S1, moving the picking robot along a cultivation frame, picking, by a suction cup, the mushrooms, and conveying, by a built-in conveying apparatus, the mushrooms to a discharge port;
S2, dynamically adjusting, according to a distribution state and maturity data of the mushrooms, a movement path of the picking robot by using a path planning algorithm, and optimizing a picking path based on a real-time position and a mushroom density;
S3, synchronously moving a receiving mechanism and the picking robot, and associating the receiving mechanism with the path planning algorithm, to ensure that the receiving mechanism is aligned to the discharge port to receive the mushrooms conveyed by the picking robot;
S4, detecting, by an image recognition apparatus mounted on the receiving mechanism, appearances, color, and shapes of the mushrooms based on a preset quality recognition algorithm, separating, by a separating apparatus, mushrooms that meet a quality standard and unqualified mushrooms, and allowing the mushrooms that meet a quality standard and the unqualified mushrooms to enter a first dropping hopper and a second dropping hopper, respectively;
S5, grading the mushrooms in the first dropping hopper for a second time, classifying the mushrooms based on volumes and diameters of the mushrooms, and guiding, by the separating apparatus, large mushrooms to a third dropping hopper, and small mushrooms to a fourth dropping hopper; and
S6, when any dropping hopper is to be fully loaded, emitting a full-load signal to trigger the receiving mechanism to alternately operate, and starting a secondary receiving mechanism to ensure that picking and collection operations are continuously performed.

2. The collaborative control method for a picking robot based on collaborative picking and collection of mushrooms according to claim 1, wherein the step S1 specifically comprises:
S11, when the picking robot moves along a guide rail of the cultivation frame, controlling, by a drive motor, the picking robot to move back and forth, wherein the drive motor fits the guide rail on the cultivation frame to implement a stable movement process, and the guide rail is provided with a positioning apparatus to ensure that the pocking robot is capable of being precisely positioned above the mushrooms;
S12, picking, by the picking robot, the mushrooms through the suction cup mounted on a robot arm, wherein the robot arm vertically stretches according to a preset picking height parameter, and the suction cup is connected to a pneumatic system, to separate mature mushrooms from mushroom bodies by using a negative pressure suction principle and stably grab the mature mushrooms; and
S13, conveying, by the picking robot through a built-in conveyor belt, the mature mushrooms grabbed by the suction cup from the suction disc to the discharge port inside the picking robot.

3. The collaborative control method for a picking robot based on collaborative picking and collection of mushrooms according to claim 1, wherein the step S2 specifically comprises:
S21, obtaining, by a visual sensor deployed on the picking robot, mushroom distribution and maturity information in a target area, wherein the sensor is configured to: scan growth positions and volumes of the mushrooms in real time, and generate relevant data;
S22, performing the path planning algorithm based on the obtained mushroom distribution and maturity information, determining an optimal movement path by analyzing a current spatial position of the picking robot, and mushroom information comprising the mushroom density, mushroom cap shielding, a mushroom height and mushroom maturity, and selecting a path on which non-destructive picking is capable of being completed within shortest time, to avoid picking in an area with immature mushrooms;
S23, automatically adjusting, by the picking robot, the movement path and a movement speed according to the calculated path, wherein in the movement process, the real-time position of the picking robot is continuously obtained, and the movement path is dynamically adjusted according to mushroom information in a to-be-picked area and newly collected data, to optimize the picking path and avoid repeated picking and missed picking; and
S24, when the picking robot approaches the target area, fine-tuning a movement position of the picking robot by using real-time feedback information to ensure that the picking robot reaches an optimal picking distance when approaching a target mushroom, to achieve a precise picking operation.

4. The collaborative control method for a picking robot based on collaborative picking and collection of mushrooms according to claim 3, wherein the step S22 specifically comprises:
S221, obtaining space distribution information of the mushrooms, and recording a current position of the picking robot to know positions of the mushrooms and a relative position of the picking robot, wherein the space distribution information comprises a three-dimensional coordinate position and maturity of each mushroom;
S222, calculating a movement distance from the picking robot to each mushroom based on a relative distance from the current position of the picking robot to each mushroom, and sorting the mushrooms according to the movement distances to give priority to a mushroom with a shorter movement distance;
S223, considering the maturity of the mushroom, and distributing a weight value to each mushroom by combining the maturity with the movement distance, and giving a higher priority μ₁ to a mushroom with higher maturity and a shorter movement distance;
S224, considering the mushroom cap shielding and the mushroom height, and giving a higher priority μ₂ to a mushroom with higher maturity, a shorter movement distance, a larger height and no shielding by combining the mushroom cap shielding, the mushroom height, and the weight μ₁ distributed in consideration of the maturity and the movement distance;
S225, selecting a mushroom with a greatest weight value μ₂ as a picking target by using a greedy algorithm, updating a position of the mushroom and the relative position of the picking robot and continuously selecting a next mushroom with a higher priority after the picking robot moves to the position of the mushroom with the greatest weight value μ₂, and repeating the process until all mushrooms that meet a maturity requirement are picked; and
S226, planning the entire picking path according to a principle of minimizing a total movement distance, to ensure that the picking robot is capable of picking all target mushrooms in a shortest path in sequence.

5. The collaborative control method for a picking robot based on collaborative picking and collection of mushrooms according to claim 4, wherein the step S24 specifically comprises:
S241, when the picking robot approaches a target mushroom area, obtaining, by a real-time position sensor, a relative distance from the picking robot to the target mushroom, and recording transverse and longitudinal position deviations between the current position of the picking robot and the target mushroom;
S242, performing position fine-tuning based on obtained position deviation information by using a proportional-integral-derivative control algorithm, and dynamically adjusting the movement speed and a movement direction of the picking robot according to a distance error, to ensure that the picking robot gradually approaches the target mushroom; and
S243, when the distance error between the picking robot and the target mushroom is reduced to be within a preset range, that is, when an optimal picking distance is reached, reducing, by a proportion integration differentiation (PID) controller, the movement speed to keep stable position precision and ensure that the suction cup is aligned to the target mushroom for picking.

6. The collaborative control method for a picking robot based on collaborative picking and collection of mushrooms according to claim 1, wherein the step S3 specifically comprises:
S31, when the picking robot is started, firstly obtaining real-time position information of the picking robot, and transmitting the real-time position information to the receiving mechanism, wherein the real-time position information comprises current coordinates and a movement speed of the picking robot on the cultivation frame;
S32, adjusting, by the receiving mechanism, a movement path of the receiving mechanism based on the real-time position information provided by the picking robot by using a synchronous tracking algorithm, to ensure that the receiving mechanism and the picking robot are kept at a consistent speed and in a consistent movement direction; and
S33, continuously monitoring relative positions between the receiving mechanism and the discharge port of the picking robot, and when a deviation is detected, automatically adjusting the movement speed and the movement direction of the receiving mechanism until the deviation between the receiving mechanism and the discharge port is reduced to be within a preset range, to ensure that the discharge port is exactly aligned to a receiving area.

7. The collaborative control method for a picking robot based on collaborative picking and collection of mushrooms according to claim 1, wherein the step S4 specifically comprises:
S41, collecting, by the image recognition apparatus, an appearance image of each collected mushroom, wherein the image recognition apparatus comprises a high-definition camera and a light source system, the high-definition camera is configured to: shoot an appearance, color and a shape feature of the mushroom, and generate corresponding digital image data, and the light source system is configured to ensure that image quality is stable;
S42, inputting the collected mushroom image data into a preset quality recognition algorithm, and comparing the collected mushroom image data with a qualified mushroom template in a quality standard library to determine whether the mushroom meets a preset standard;
S43, classifying the mushrooms into qualified mushrooms and unqualified mushrooms according to a detection result in S42, wherein the qualified mushroom has an appearance, color, and a shape feature that meet a set standard, and the unqualified mushroom has an obvious difference and defect from the qualified mushroom template; and
S44, after the detection result is transmitted to a central control system, starting the separating apparatus according to a determining result, wherein the separating apparatus is configured to: control runners in two different directions through an executor, guide the qualified mushrooms to the first dropping hopper through one hopper, and guide the unqualified mushrooms to the second dropping hopper through the other runner.

8. The collaborative control method for a picking robot based on collaborative picking and collection of mushrooms according to claim 7, wherein the step S42 specifically comprises:
S421, preprocessing, by the image recognition apparatus, the collected mushroom image, wherein the preprocessing comprises noise removal, color balance adjustment, and edge detail enhancement; and after image processing, extracting color information and brightness information of each pixel, wherein the color information comprises red color, green color, and blue color;
S422, extracting feature information of the mushroom from the preprocessed image by using a convolutional neural network, wherein the feature information comprises color information and shape parameters of the mushrooms, the color information is obtained by analyzing a color histogram, and specifically comprises color distribution of red, green, and blue channels; and the shape parameter is extracted through edge detection and outline analysis, and is used to reflect symmetry, a shape, and a surface feature of the mushroom;
S423, comparing the extracted mushroom feature information with the preset qualified mushroom template in the quality standard library, wherein the template comprises color and a shape feature of a standard mushroom; and estimating a matching degree between the appearance, color, and shape of the mushroom with the appearance, color, and shape in an eligibility standard by calculating a difference value between the mushroom and the qualified mushroom template; and
S424, according to a comparison result, determining whether the mushroom meets a preset quality standard based on the difference value between the mushroom and the qualified template; and determining that the mushroom is a qualified mushroom if a feature difference of the mushroom is within a preset tolerance range; or determining that the mushroom is an unqualified mushroom if the feature difference of the mushroom exceeds a preset tolerance range.

9. The collaborative control method for a picking robot based on collaborative picking and collection of mushrooms according to claim 1, wherein the step S5 specifically comprises:
S51, in the first dropping hopper, measuring, by the image recognition apparatus, a volume and a diameter of each mushroom;
S52, separately comparing the volume and the diameter with a preset volume grading standard, and setting different volume thresholds and diameter thresholds based on types and specifications of the mushrooms according to the volume grading standard; and if both a volume and a diameter of the mushroom exceed the preset thresholds, determining that the mushroom is a large mushroom; or if both a volume and a diameter of the mushroom are lower than the preset thresholds, determining that the mushroom is a small mushroom; and
S53, guiding the large mushroom to the third dropping hopper according to a grading result, and guiding the small mushroom to the fourth dropping hopper according to a determining result, to avoid that mushrooms of different volumes are mixed.

10. The collaborative control method for a picking robot based on collaborative picking and collection of mushrooms according to claim 1, wherein the step S6 specifically comprises:
S61, mounting a load sensor in each dropping hopper, wherein the load sensor is configured to: monitor a current load of the dropping hopper in real time, and transmit current weight data W that is measured by the load sensor to the central control system, wherein W is an actual weight of the dropping hopper;
S62: continuously monitoring, by the central control system, the current weight W according to a preset full-load threshold Wₘₐₓ; and when the current weight W measured by the load sensor is close to or equal to the full-load threshold Wₘₐₓ, that is, when W≥Wₘₐₓ is met, automatically emitting, by the central control system, a full-load signal; and
S63, after the full-load signal is transmitted to the central control system, triggering the secondary receiving mechanism to start; after the secondary receiving mechanism is in a standby state in advance and the full-load signal is emitted, sending, by the central control system, an instruction to an executor, and switching a receiving path by the executor, to ensure that the secondary receiving hopper takes over an existing receiving hopper, to continuously perform a receiving operation.
